(19) United States
(12) Patent Application Publication
(10) Pub. No.: US 2005/0199757 A1
(43) Pub. Date: Sep. 15, 2005

(54) End plate and roll mill equipped with end plate

(75) Inventor: Masahiro Sano, Hatano-shi (JP)

Correspondence Address: BRUCE L. ADAMS, ESQ., 31ST FLOOR, 50 BROADWAY, NEW YORK, NY, 10004, US

(73) Assignee: Inoue Mfg., Inc.

(21) Appl. No.: 11/061,493

(22) Filed: Feb. 18, 2005

(30) Foreign Application Priority Data
Feb. 23, 2004 (JP) 2004-45602

(51) Int. Cl. B02C 1/08

(52) U.S. Cl. 241/226

(57) ABSTRACT

An end plate is adapted for use in a roll mill having at least two rolls mounted to undergo rotational movement for milling and dispersing a material introduced between the rolls. The end plate comprises a main body having at least a surface portion made of a ceramic material for slidable contact with peripheral surfaces of the rolls during a milling and dispersing treatment.

### BACKGROUND OF THE INVENTION

1. Field of the Invention

The present invention relates generally to roll mills and, more specifically, to a roll mill used for a milling and dispersing treatment of materials in production steps of various products such as printing inks, cosmetics, paints, foods, medicines and materials for electronic components. The present invention also relates to an end plate for use in the roll mill.

2. Background Information

A conventional roll mill such as, for example, a three-roll mill, is disclosed in JP-A-2004-25075. The conventional roll mill has a rear roll, an intermediate roll and a front roll adjoining one another. The roll mill is constructed so that the material to be treated by mixing, milling and dispersing is poured between the rear roll and the intermediate roll, is passed through a gap between the rolls, is ground, milled and transferred to the front roll, and is removed by a doctor knife or like device adjacent to the front roll. Additionally, end plates are provided at opposite sides of the rear roll and the intermediate roll to block side spaces between the rolls so that the material poured between the rolls will not run down from the sides of the rolls.

The material forming the end plates has been selected taking into account the sealing properties of the material to be treated and to facilitate rubbing or sliding contact between the contacting surfaces of the rollers and the end plates. For example, a copper alloy or an engineering plastic such as polyacetal or nylon has been used as the material forming the end plates. Since the end plates are in slidable contact with the roll surfaces in order to maintain the sealing properties during operation of the roll mill, abrasion is caused which results in foreign matter, such as abrasion powder, being mixed in with the material being treated. The inclusion of abrasion powder, even if in minute amounts, brings about problems, such as contamination, depending on the type of product for which the material is used. For example, when the material being treated is to be used for producing electronic components, contamination caused by the inclusion of foreign matter causes various problems, including malfunction of the resulting electronic component.

Another problem with the conventional roll mill is that the construction of the end plates is insufficient to prevent breakage or fracture of the end plates, particularly due to their continuous sliding contact with the rolls. Additionally, the end plates of the conventional roll mill have not been constructed of light-weight materials, thereby increasing the overall weight, and thus the overall cost, of the roll mill.

### SUMMARY OF THE INVENTION

It is an object of the present invention to provide a roll mill which prevents contamination of the material to be treated by greatly reducing abrasion of the end plates which are in slidable contact with surfaces of rolls of the roll mill during a milling and dispersing treatment of the material.

It is another object of the present invention to provide a roll mill having end plates which are disposed in sliding contact with surfaces of the rolls during a milling and dispersing treatment and which are strong, lightweight, and inexpensive to manufacture.

It is yet another object of the present invention to provide a roll mill which is cost effective yet operationally efficient.

The foregoing and other objects of the present invention are carried out by an end plate for a roll mill having a plurality of rolls mounted to undergo rotational movement during a milling and dispersing treatment for milling and dispersing a material to be treated introduced between the rolls. The end plate comprises a main body having at least a surface portion made of a ceramic material for slidable contact with peripheral surfaces of the rolls during a milling and dispersing treatment by the roll mill.

In another aspect, the present invention is directed to a roll mill comprising at least two adjacent rolls mounted to undergo rotational movement during a milling and dispersing treatment for mixing, milling and dispersing a material to be treated introduced between the rolls. Each of a pair of end plates has at least a surface portion made of a ceramic material. The end plates are disposed at respective opposite ends of the rolls so that during a milling and dispersing treatment, the ceramic surface portion of one of the end plates is disposed in slidable contact with the peripheral surfaces of the rolls at one of the ends thereof and the ceramic surface portion of the other of the end plates is disposed in slidable contact with the peripheral surfaces of the rolls at the other ends thereof.

In one embodiment, each of the end plates is formed from a single piece of ceramic material which includes the surface portion for slidable contact with the peripheral surfaces of the rolls.

In another embodiment, each of the end plates has opposite main surfaces. A ceramic layer is disposed on one of the main surfaces which includes the surface portion for slidable contact with the peripheral surfaces of the rolls. Preferably, the ceramic layer comprises a thermally-sprayed ceramic layer formed by thermally spraying a ceramic material on the main surface of the end plate.

In another embodiment, each of the end plates has a main body comprised of a substrate and a plate member detachably connected to the substrate. The plate member is formed from a single piece of ceramic material which includes the surface portion for slidable contact with the peripheral surfaces of the rolls.

In a further embodiment, each of the end plates has a main body comprised of a substrate and a plate member detachably connected to the substrate. The plate member is comprised of a base portion and a ceramic layer disposed on the base portion. The ceramic layer has the surface portion for slidable contact with the peripheral surfaces of the rolls. Preferably, the ceramic layer comprises a thermally-sprayed ceramic layer formed by thermally spraying a ceramic material on a surface of the base portion.

In a still further embodiment which may be combined with any of the foregoing embodiments of the end plates, a ceramic layer is formed on at least peripheral surface portions of each of the rolls for slidable contact with the corresponding ceramic surface portions of the end plates.

By the foregoing construction, the surface portion of each of the end plates for slidable contact with the peripheral surfaces of the rolls is made of a ceramic layer which has high abrasion resistance, heat resistance, and hardness. As a result, the amount or degree of abrasion resulting from the slidable contact between the surface portion of each of the end plates for slidable contact with the peripheral surfaces of the rolls is substantially reduced as compared with conventional end plates made of copper alloys or engineering plastics. By substantially reducing the amount or degree of abrasion, the risk of contaminating the material to be treated with abrasion powder during a milling and dispersing treatment is prevented.

According to the present invention, when a ceramic layer is formed on at least peripheral surface portions of each of the rolls for slidable contact with the corresponding ceramic surface portions of the end plates, contamination by inclusion of abrasion powder into the material to be treated can further be prevented.

Moreover, by forming each of the end plates from a single piece of ceramic material, production of the end plate is facilitated. Furthermore, when a ceramic layer is thermally sprayed on the main surface of each end plate, or when a ceramic layer is thermally sprayed on a surface of the base portion of each end plate, the end plate is hardly subjected to cracks and chips. Thus, there is less probability that chipped pieces of the end plates enter in gaps between the rolls and damage the rolls.

Additionally, by providing each of the end plates with a detachable plate member which is made of a ceramic material or which has a ceramic layer, the overall weight of the end plate can be reduced when the substrate is formed of a light-weight material, such as a suitable plastic material. These embodiments also facilitate handling of the end plates during a cleaning operation and/or during installation of the end plates relative to the rolls. Furthermore, when the ceramic layer is abraded after a long period of use, another ceramic layer can be thermally sprayed so that the end plates can be economically repaired.

### BRIEF DESCRIPTION OF THE DRAWINGS

The foregoing summary, as well as the following detailed description of preferred embodiments of the invention, will be better understood when read in conjunction with the accompanying drawings. For the purpose of illustrating the invention, there is shown in the drawings embodiments which are presently preferred. It should be understood, however, that the invention is not limited to the precise arrangement and instrumentalities shown. In the drawings:

FIG. 1 is an explanatory view showing an embodiment of the roll mill according to the present invention;

FIG. 2 is an enlarged partial cross-sectional view of the rolls and one of the end plates in the roll mill shown in FIG. 1;

FIG. 3 is a perspective view showing an embodiment of the end plate according to the present invention;

FIG. 4 is an enlarged partial cross-sectional view of another embodiment of the end plate according to the present invention showing a thermally-sprayed ceramic layer;

FIG. 5 is an enlarged partial cross-sectional view of the end plate shown in FIGS. 3;

FIG. 6 is a perspective view showing another embodiment of the end plate according to the present invention; and

FIG. 7 is a perspective view showing another embodiment of the end plate according to the present invention.

### DETAILED DESCRIPTION OF THE PREFERRED EMBODIMENTS

While this invention is susceptible of embodiments in many different forms, this specification and the accompanying drawings disclose only certain examples of the use of the invention. The invention is not intended to be limited to the embodiments so described, and the scope of the invention will be pointed out in the appended claims.

Throughout the following description and drawings, identical reference numbers are used to refer to the same components shown in multiple figures of the drawings.

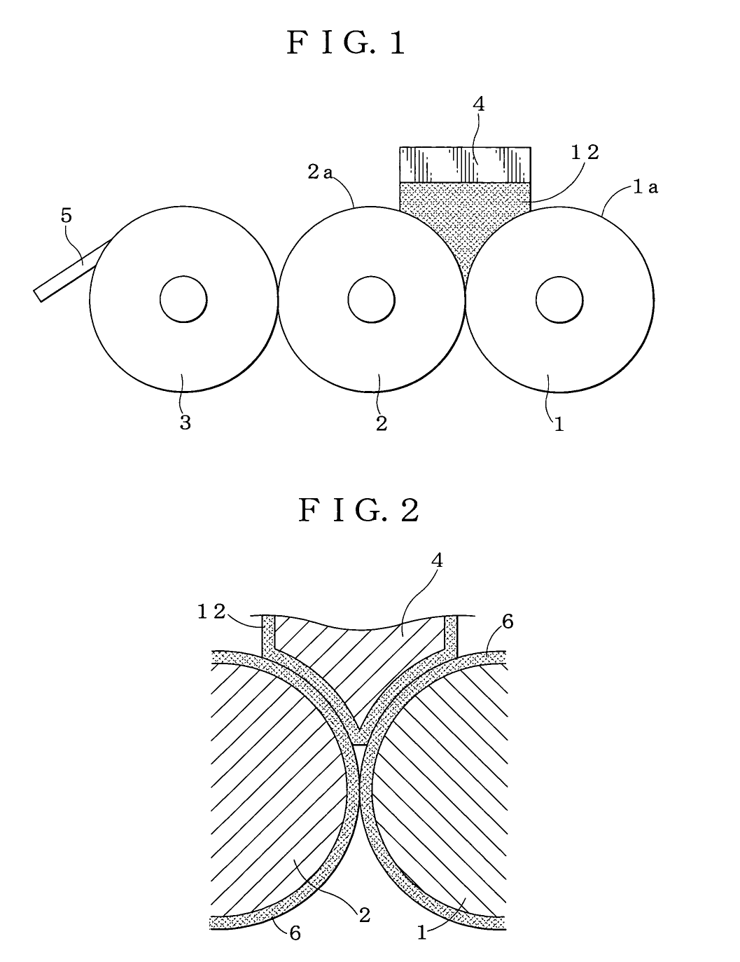

Referring now to the drawings in detail, wherein like numerals are used to indicate like elements throughout, there is shown in FIG. 1 an embodiment of a roll mill according to the present invention. FIG. 1 illustrates a three-roll mill having a rear roll 1, an intermediate roll 2 adjacent the rear roll 1, and a front roll 3 adjacent the intermediate roll 2. The roll mill is used for a milling and dispersing treatment in which a material to be treated is poured between the rear roll 1 and the intermediate roll 2 and is mixed, milled, dispersed, and transferred to the front roll 3, at which point the treated material is scraped with a doctor knife 5 or like device. The rear, intermediate and front rolls 1-3 may comprise steel rolls (e.g., chilled rolls), for example. Other specific structure for the rear, intermediate, and front rolls 1-3, including the structure and mechanism for rotationally mounting and driving the rolls, is well known in art and is therefore omitted from this description.

As shown in FIGS. 1-2, the roll mill of the present invention has a pair of end plates 4 each disposed at respective opposite ends of the rear roll 1 and the intermediate roll 2 so that a surface portion 12 of each of the end plates 4 confronts respective peripheral surfaces 1a, 2a of the rear and intermediate rolls 1, 2. Only one of the end plates 4 is shown in FIG. 1 to facilitate visualization of the relative position between the surface portion 12 of the end plate 4 and the peripheral surfaces 1a, 2a at one of the ends of the rear and intermediate rolls 1, 2. However, it is understood that the other end plate 4 is located at the ends of the rear and intermediate rolls 1, 2 opposite to the ends at which the end plate 4 shown in FIG. 1 is located (i.e., the other end plate 4 confronts the end plate 4 shown in FIG. 1 with the corresponding portions of the rear and intermediate rolls 1, 2 disposed therebetween).

During a milling and dispersing treatment, the surface portion 12 of one of the end plates 4 is disposed in slidable contact with the peripheral surfaces 1a, 2a of the rear and intermediate rolls 1, 2 at one of the ends thereof, and the surface portion of the other end plate 4 is disposed in slidable contact with the peripheral surfaces 1a, 2a of the rear and intermediate rolls 1, 2 at the other ends thereof. By this construction, the end plates 4 prevent the material which is poured between the rear and intermediate rolls 1, 2 from running down from the ends of the rear and intermediate rolls. The manner of connecting the end plates 4 relative to the rear and intermediate rolls 1, 2 so that the surface portions of the end plates 4 are disposed in slidable contact with respective peripheral surfaces 1a, 2a of the rear and intermediate rolls 1, 2 during a milling and dispersing treatment is well known in the art and, therefore, a detailed description thereof is omitted.

According to the present invention, the surface portion 12 of each of the end plates 4 is made of a ceramic material having high abrasion resistance, high heat resistance and high hardness. For example, the ceramic material comprises alumina (Al₂O₃) or zirconia (ZrO₂). Other ceramic materials are suitable for the surface portion 12 of the end plates 4 so long as they exhibit the desired high abrasion resistance, heat resistance and hardness properties.

During a milling and dispersing treatment, the ceramic surface portions 12 of the end plates 4 are in slidable contact with the peripheral surfaces 1a, 2a of the rear and intermediate rolls 1, 2. By this construction, due to the high abrasion resistance, heat resistance, and hardness of the ceramic material from which the surface portions 12 are made, the amount or degree of abrasion resulting from the slidable contact between the surface portions 12 of the end plates and the peripheral surfaces 1a, 2a of rear and intermediate rolls 1, 2 is substantially reduced as compared with conventional end plates made of copper alloys or engineering plastics. By substantially reducing the amount or degree of abrasion, the risk of contaminating the material to be treated with abrasion powder during a milling and dispersing treatment is prevented.

FIG. 2 is a partial cross-sectional view showing the relative position between one of the end plates 4 and the rear and intermediate rolls 1, 2. FIG. 2 depicts an embodiment of the roll mill in which a ceramic layer 6, having the properties described above for the ceramic surface portions 12 of the end plates 4, is formed on peripheral surface portions of the rear and intermediate rolls 1, 2 which are in slidable contact with the surface portions 12 of the end plates 4. By this combination, since the sliding contacting surfaces between the end plates 4 and the rear and intermediate rolls 1, 2 are made of ceramic material, the amount or degree of abrasion is further reduced.

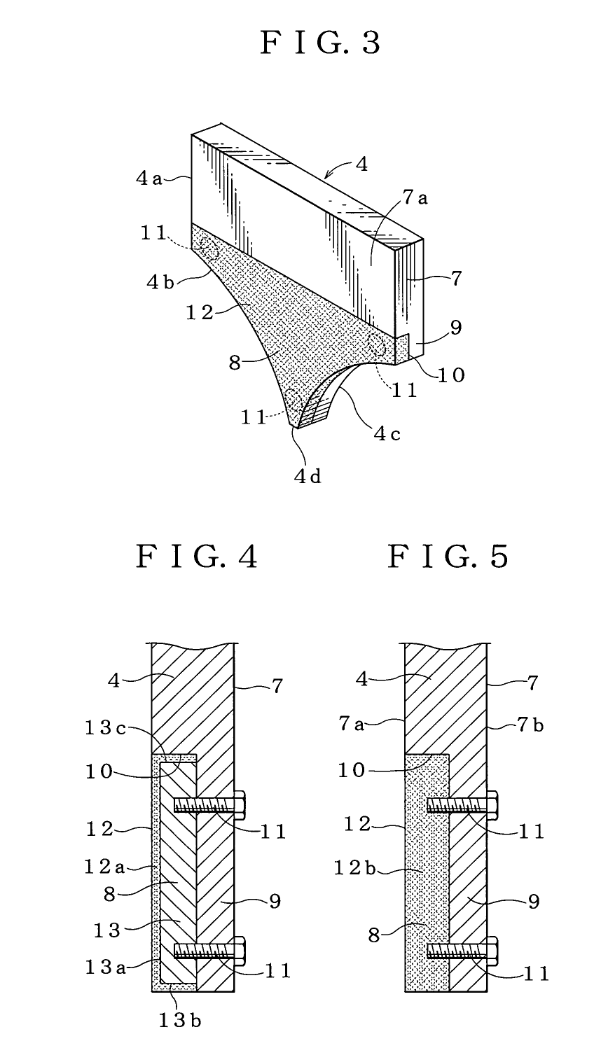

It will be appreciated by those skilled in the art that the embodiment of the rear and intermediate rolls 1, 2 shown in FIG. 2 (i.e., the rolls 1, 2 having the ceramic layer 6) can be used in combination with any of the end plates 4 described below in accordance with the embodiments shown in FIGS. 3-7.

FIGS. 3-7 show various embodiments of the construction of the end plates 4 according to the present invention. The general configuration (e.g., the outer contour) of the end plates 4 is selected to conform to the structure of the adjacent rolls of the roll mill to which the end plates are disposed in slidable contact during a milling and dispersing treatment. For example, in the embodiments shown in FIGS. 3-7, each of the end plates 4 has a generally rectangular-shaped upper portion 4a and a lower portion 4b with two curved side surfaces 4c terminating at a truncated tip 4d (see FIG. 3). The lower portion 4b of the end plate has the ceramic surface portion 12 for slidable contact with the peripheral surfaces 1a, 2a of the rolls 1, 2 as described above. The lower portion 4b conforms to the circular shape of the adjacent rolls to which it is disposed in slidable contact and to the shape of the space formed at the intersection of the adjacent rolls (i.e., the space in which the truncated tip 4d of the end plate is located) (see FIG. 2). It is understood, however, that the configuration of the end plates 4 is not limited to that shown in FIGS. 2-7, and the particular configuration is selected in accordance with the configuration of the rolls used for the roll mill.

FIGS. 3 and 5 show one embodiment of the end plate 4 according to the present invention. The end plate 4 has a main body 7 having opposite main surfaces 7a, 7b and comprised of a substrate 9 and a plate member 8 detachably connected to the substrate 9. More specifically, the lower portion 4b of the end plate 4 has an undercut or receiving section 10 which accommodates the plate member 8 so that outer surfaces of the substrate 9 and the plate member 8 are flush and define the main surface 7a of the main body 7. The plate member 8 is integrally connected in the receiving portion 10 of the substrate 9 with bolts 11. It is understood, however, that other types of connect means, such as an adhesive, are suitable for connecting the plate member to the substrate 9.

In the embodiment shown in FIGS. 3 and 5, the plate member 8 has the surface portion 12 for slidable contact with the peripheral surfaces 1a, 2a of the rear and intermediate rolls 1, 2 during a milling and dispersing treatment. The plate member 8 is made of a single piece of ceramic material defining a single ceramic layer 12b of the end plate 4. As the ceramic material, alumina (Al₂O₃) or zirconia (ZrO₂), for example, is preferably selected due to its high abrasion resistance, heat resistance and hardness properties. Preferably, the substrate 9 to which the plate member 8 is connected is made of a light-weight plastic material. By this construction, handling of the end plate 4 during a cleaning operation and/or during installation of the end plate 4 relative to the rolls 1, 2 is facilitated. Furthermore, when the ceramic plate member 8 is abraded after a long period of use, the abraded ceramic plate member 8 can be readily replaced with a new ceramic plate member, thereby facilitating repair and lowering operation downtime of the roll mill. Furthermore, the overall weight of the end plate 4 can be substantially reduced when the substrate 9 is formed of a light-weight plastic material.

FIG. 4 shows another embodiment of the end plate 4 according to the present invention. The overall structure of the end plate 4 in FIG. 4 is substantially the same as the structure of the end plate 4 shown in FIGS. 3 and 5 except for the plate member 8. In the embodiment of FIG. 4, the plate member 8 comprises a base portion 13 and a ceramic layer 12a disposed on a main surface 13a and side surfaces 13b, 13c of the base portion 13. The portion of the ceramic layer 12a disposed on the main surface 13a includes the surface portion 12 for slidable contact with the peripheral surfaces 1a, 2a of the rear and intermediate rolls 1, 2. The base portion 13 is preferably made of a ductile metal material, such as copper alloy. By disposing the ceramic layer 12a on the main surface 13a and side surfaces 13b, 13c of the base portion 13 made of a ductile metal material, cracking and/or chipping of the ceramic layer 12 due to the brittle nature of the ceramic material itself is substantially reduced.

Preferably, the ceramic layer 12a is thermally sprayed on the main surface 13a and side surfaces 13b, 13c of the base portion 13. Prior to thermally spraying the ceramic layer 12a, the main and side surfaces 13a-13c of the base portion 13 are subjected to appropriate treatments in order to insure proper adhesion of the ceramic layer 12a to the main and side surfaces of the base portion 13. For example, the main and side surfaces 13a-13c of the base portion 13 are first subjected to a surface treatment by sand blasting or the like. A coating material of Ni—Cr, for example, is applied on the main and side surfaces 13a-13c of the base portion 13 after being subjected to the surface treatment. Thereafter, the ceramic material is thermally sprayed on the main and side surfaces 13a-13c of the base portion 13 to form the ceramic layer 12a. Preferably, the ceramic material is thermally sprayed to a thickness of about 100 μm to 400 μm. By this method and construction, the adhesion of the ceramic layer 12a to the main and side surfaces of the base portion 13 is improved and a ceramic layer 12a with high-quality surface properties can be obtained.

According to the present invention, the ceramic layer 12a can be re-sprayed by thermal spraying when the ceramic layer 12a is abraded after a long period of use. This provides an end plate which is economical to repair since it does not require replacement of the base portion 13 and/or the substrate 9.

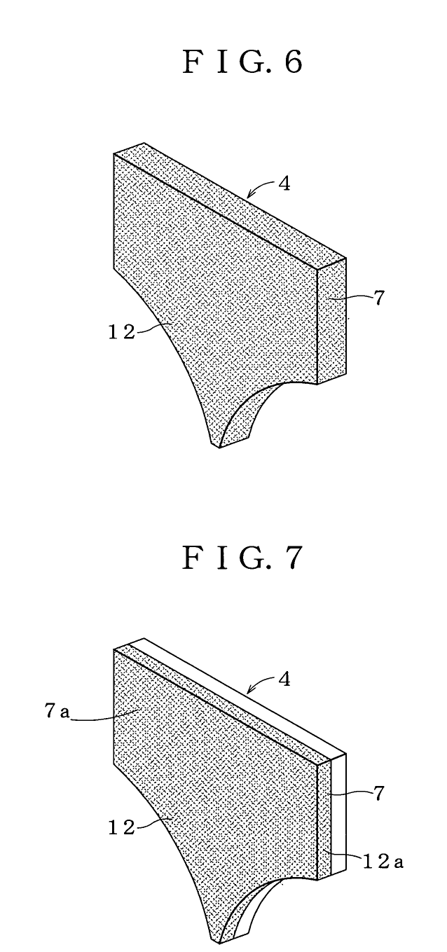

FIG. 6 shows another embodiment of the end plate 4 according to the present invention. In this embodiment, the main body 7 of the end plate 4 (i.e., the entire end plate 4) is made from a single piece of ceramic material which includes the surface portion 12 for slidable contact with the peripheral surfaces 1a, 2a of the rear and intermediate rolls 1, 2. By this construction, production of the end plate 4 is facilitated.

FIG. 7 shows another embodiment of the end plate 4 according to the present invention. In this embodiment, a ceramic layer 12a is disposed on the entire main surface 7a of the main body 7 of the end plate 4. The ceramic layer 12a includes the surface portion 12 for slidable contact with the peripheral surfaces 1a, 2a of the rear and intermediate rolls 1, 2. Preferably, the ceramic layer is thermally sprayed on the main surface 7a of the main body 7. Prior to thermally spraying the ceramic layer 12a, the main surface 7a is preferably subjected to appropriate treatments in order to insure proper adhesion of the ceramic layer 12a to the main surface 7a as described above for the embodiment of the end plate 4 shown in FIG. 4. Preferably, the ceramic material forming the ceramic layer 12a is thermally sprayed to a thickness of about 100 μm to 400 μm. By this method and construction, the adhesion of the ceramic layer 12a to the main surface 7a of the main body 7 is improved and a ceramic layer 12a with high-quality surface properties can be obtained. Furthermore, as described above for the embodiment of FIG. 4, the ceramic layer 12a can be re-sprayed by thermal spraying when the ceramic layer 12a is abraded after a long period of use. This provides an end plate which is economical to repair since it does not require replacement of the entire main body 7 (i.e., replacement of the entire end plate 4).

In the embodiments shown in FIGS. 4, 6 and 7, the ceramic material is preferably the same as that selected for the ceramic material described above with reference to the embodiment of FIGS. 3 and 5.

An example of the construction of the end plates of the present invention and the results of a test conducted using the end plates in the roll mill according to the present invention is described below with reference to FIGS. 1, 2 and 4.

For each end plate 4, the base portion 13 was prepared using a copper alloy. The main and side surfaces 13a-13c of the base portion 13 were first subjected to a sand blasting treatment or the like and a coating material of Ni—Cr, for example, was applied on the main and side surfaces 13a-13c of the base portion 13. Thereafter, the ceramic material was thermally sprayed on the main and side surfaces 13a-13c of the base portion 13 to form the ceramic layer 12a having a finished thickness of about 300 μm. The prepared base portion 13 was then integrally connected to the substrate 9 made of a light-weight plastic material using bolts 11 to form the end plate 4.

The thus formed end plates 4 were positioned relative to the rear and intermediate rolls 1, 2 of the roll mill, as described above and shown in FIG. 1. The rear and intermediate rolls 1, 2 used in this test were each provided with the ceramic layer 6 on peripheral surface portions thereof with which the ceramic surface portions 12 of the end plates 4 are in slidable contact during a milling and dispersing treatment.

Thereafter, a 3-hour milling and dispersing treatment operation was conducted for a material poured between the rear and intermediate rolls 1, 2. The abrasion amount and corresponding abrasive powder at a contact site corresponding to the sliding contact between the ceramic surface portions 12 of the end plates 4 and the peripheral surfaces 1a, 2a of the end plates 4 was extremely reduced as compared to a milling and dispersing treatment using a conventional roll mill. For example, when a similar treatment was conducted using an end plate made of an engineering plastic such as polyacetal or nylon, abrasion of about 1 mm to 2 mm was caused at the contact site. Moreover, when the test was conducted using the end plates according to the present invention, it was noticed that there was no contamination of the treated material due to the abrasion. In contrast, contamination of the treated material was noticed when the test was conducted using the end plates of the conventional art.

The foregoing embodiments of the present invention have been described in connection with a three-roll mill. However, it is understood by those skilled in the art that the effects and advantages of the present invention can also be achieved by a two-roll mill or a roll mill having more than three rolls.

Thus, the present invention provides a roll mill comprising rolls and end plates having surface portions made of a ceramic material for slidable contact with peripheral surfaces of the rolls during a milling and dispersing treatment. As a result of the high abrasion resistance, heat resistance, and hardness of the ceramic material, the amount or degree of abrasion resulting from the slidable contact between the surface portions of the end plates and the peripheral surfaces of the rolls is substantially reduced as compared with conventional end plates made of copper alloys or engineering plastics. By substantially reducing the amount or degree of abrasion, the risk of contaminating the material to be treated with abrasion powder during a milling and dispersing treatment is prevented. This is particularly important when the material to be treated is used as a material for producing electronic components, where contamination caused by the inclusion of foreign matter causes various problems, including malfunction of the resulting electronic component.

According to the present invention, when a ceramic layer is formed on at least the peripheral surface portions of each of the rolls for slidable contact with the corresponding ceramic surface portions of the end plates, contamination by inclusion of abrasion powder into the material to be treated can further be prevented.

Moreover, by forming each of the end plates from a single piece of ceramic material, production of the end plate is facilitated. Furthermore, when a ceramic layer is thermally sprayed on the main surface of each end plate, or when a ceramic layer is thermally sprayed on a surface of the base portion of each end plate, the end plate is hardly subjected to cracks and chips. Thus, there is less probability that chipped pieces of the end plates enter in gaps between the rolls and damage the rolls.

Additionally, by providing each of the end plates with a detachable plate member which is made of a ceramic material or which has a ceramic layer, the overall weight of the end plate can be reduced when the substrate is formed of a light-weight material, such as a suitable plastic material. These embodiments also facilitate handling of the end plates during a cleaning operation and/or during installation of the end plates relative to the rolls. Furthermore, when the ceramic layer is abraded after a long period of use, another ceramic layer can be thermally sprayed so that the end plates can be economically repaired.

From the foregoing description, it can be seen that the present invention comprises an improved end plate and roll mill equipped with the end plate. It will be appreciated by those skilled in the art that obvious changes can be made to the embodiments described in the foregoing description without departing from the broad inventive concept thereof. It is understood, therefore, that this invention is not limited to the particular embodiments disclosed, but is intended to cover all obvious modifications thereof which are within the scope and the spirit of the invention as defined by the appended claims.

1. An end plate for a roll mill having a plurality of rolls mounted to undergo rotational movement for milling and dispersing a material introduced between the rolls, the end plate comprising: a main body having at least a surface portion made of a ceramic material for slidable contact with peripheral surfaces of the rolls during a milling and dispersing treatment by the roll mill.

2. An end plate according to claim 1; wherein the main body is made from a single piece of ceramic material.

3. An end plate according to claim 1; wherein the main body has a main surface and a ceramic layer disposed on the main surface, the ceramic layer having the ceramic surface portion for slidable contact with the peripheral surfaces of the rolls during a milling and dispersing treatment by the roll mill.

4. An end plate according to claim 3; wherein the ceramic layer comprises a thermally-sprayed ceramic layer.

5. An end plate according to claim 4; wherein the thermally-sprayed ceramic layer has a thickness in the range of 100 μm to 400 μm.

6. An end plate according to claim 1; wherein the main body comprises a substrate and a plate member connected to the substrate, the plate member having the ceramic surface portion for slidable contact with the peripheral surfaces of the rolls during a milling and dispersing treatment by the roll mill.

7. An end plate according to claim 6; wherein the plate member is made from a single piece of ceramic material.

8. An end plate according to claim 7; wherein the substrate is made of a light-weight plastic material.

9. An end plate according to claim 6; wherein the plate member comprises a base portion and a ceramic layer disposed on the base portion, the ceramic layer having the ceramic surface portion.

10. An end plate according to claim 9; wherein the ceramic layer comprises a thermally-sprayed ceramic layer.

11. An end plate according to claim 10; wherein the thermally-sprayed ceramic layer has a thickness in the range of 100 μm to 400 μm.

12. An end plate according to claim 6; wherein the plate member is detachably connected to the substrate.

13. An end plate according to claim 12; wherein the substrate is made of a light-weight plastic material.

14. A roll mill comprising:
a pair of adjacent rolls mounted to undergo rotational movement during a milling and dispersing treatment for milling and dispersing a material introduced between the rolls; and
a pair of end plates each having at least a surface portion made of a ceramic material, the end plates being disposed at respective opposite ends of the rolls so that during a milling and dispersing treatment, the ceramic surface portion of one of the end plates is disposed in slidable contact with peripheral surfaces of the rolls at one of the ends thereof and the ceramic surface portion of the other of the end plates is disposed in slidable contact with the peripheral surfaces of each of the rolls at the other of the ends thereof.

15. A roll mill according to claim 14; wherein each of the end plates is made from a single piece of ceramic material having the ceramic surface portion.

16. A roll mill according to claim 14; wherein each of the end plates comprises a main body having a main surface and a ceramic layer disposed on the main surface, the ceramic layer having the ceramic surface portion.

17. A roll mill according to claim 16; wherein the ceramic layer comprises a thermally-sprayed ceramic layer.

18. A roll mill to claim 17; wherein the thermally-sprayed ceramic layer has a thickness in the range of 100 μm to 400 μm.

19. A roll mill according to claim 14; wherein each of the end plates has a main body comprised of a substrate and a plate member connected to the substrate, the plate member having the ceramic surface portion.

20. A roll mill according to claim 19; wherein the plate member is made from a single piece of ceramic material.

21. A roll mill according to claim 20; wherein the substrate is made of a light-weight plastic material.

22. A roll mill according to claim 19; wherein the plate member comprises a base portion and a ceramic layer disposed on the base portion, the ceramic layer having the ceramic surface portion.

23. A roll mill according to claim 22; wherein the ceramic layer comprises a thermally-sprayed ceramic layer.

24. A roll mill according to claim 23; wherein the thermally-sprayed ceramic layer has a thickness in the range of 100 μm to 400 μm.

25. A roll mill according to claim 19; wherein the substrate is made of a light-weight plastic material.
